(19) United States
(12) Patent Application Publication
(10) Pub. No.: US 2026/0281003 A1
(43) Pub. Date: Sep. 17, 2026

(54) Scheduling Requests for AI/ML-Based Model Status Reporting

(71) Applicant: Apple Inc., Cupertino, CA (US)

(72) Inventors: Ping-Heng Kuo, London (GB); Peng Cheng, Beijing (CN); Ralf Rossbach, Munich (DE); Haijing Hu, Los Gatos, CA (US); Naveen Kumar R. Palle Venkata, San Diego, CA (US); Yuqin Chen, Beijing (CN); Fangli Xu, Beijing (CN); Sethuraman Gurumoorthy, San Ramon, CA (US); Alexander Sirotkin, Hod Hasharon (IL)

(21) Appl. No.: 19/167,221

(22) PCT Filed: Mar. 14, 2024
(86) PCT No.: PCT/US2024/019874

§ 371 Date: Sep. 19, 2025

Related U.S. Application Data
(60) Provisional application No. 63/491,133, filed on Mar. 20, 2023.

(51) Int. Cl. H04L 41/16; H04W 72/21; H04W 74/0833

(52) U.S. Cl. CPC H04L 41/16; H04W 72/21; H04W 74/0833

(57) ABSTRACT

The present application relates to improved user equipment (UE) behaviors in instances of the degradation of stored models related to Artificial Intelligence (AI) and/or Machine Learning (ML)-based tasks or functions (i.e., “AI/ML models”). AI/ML models should be updated rapidly when they have degraded (or failed). However, UEs may not have immediate uplink-shared channel (UL-SCH) resources available for the transmission of AI/ML model status reports to a gNodeB (gNB), e.g., via a Medium Access Control (MAC) Control Element (CE) or a Radio Resource Control (RRC) message, so there may be an undesirable amount of delay before a UE is able to inform the gNB that some or all of its AI/ML models are either suffering from degraded performance or are no longer valid for performance of their respective tasks or functions. Described herein are techniques to allow UEs to obtain UL-SCH resources for transmission of AI/ML model status reports more rapidly.

### TECHNICAL FIELD

The present application relates to wireless devices and wireless networks, including user devices, terminals, circuits, computer-readable media, and methods for Artificial Intelligence (AI)/Machine Learning (ML) model quality monitoring and fast recovery under model degradation or failure detection.

### BACKGROUND

Wireless communication systems are rapidly growing in usage. In recent years, wireless devices such as smart phones and tablet computers have become increasingly sophisticated. In addition to supporting telephone calls, many mobile devices now provide access to the Internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), Long-Term Evolution (LTE), LTE Advanced (LTE-A), HSPA, 3GPP2 CDMA2000 (e.g., 1×RTT, 1×EV-DO, HRPD, eHRPD), IEEE 802.11 (WLAN or Wi-Fi), and BLUETOOTH™, among others.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including the fifth generation (5G) standard and New Radio (NR) communication technologies. Accordingly, improvements in the field in support of such development and design are desired.

In particular, sophisticated models may be developed and deployed to UEs related to Artificial Intelligence (AI) and/or Machine Learning (ML)-based tasks or functions (i.e., “AI/ML models”). However, UEs may not necessarily have immediate uplink-shared channel (UL-SCH) resources available for the transmission of status reports regarding such AI/ML models to a cellular network gNodeB (gNB), resulting in an undesirable amount of delay before the UE is able to inform the gNB that some or all of the AI/ML models are either suffering from degraded performance or are no longer valid for performance of their respective tasks or function. Thus, it would be desirable to have techniques allowing UEs to obtain UL-SCH resources for transmission of status reports relating to AI/ML models more rapidly.

### SUMMARY

In accordance with one or more aspects, a method of operating a user equipment (UE) is disclosed herein, the method comprising: obtaining, at the UE, at least a first model, wherein the first model relates to at least one task or function that is based on artificial intelligence (AI) or machine learning (ML); receiving, at the UE (e.g., via a Radio Resource Control (RRC) message), a configuration from a base station that associates a first scheduling request (SR) configuration with a status report for the first model; detecting, at the UE, a need to send a message to the base station regarding a status report for the first model; determining, at the UE, that an uplink shared channel (UL-SCH) resource is not available for transmission of the message to the base station; and triggering, by the UE, a transmission of a first SR to the base station on the Physical Uplink Control Channel (PUCCH), wherein the first SR is based on the first SR configuration.

According to some aspects, the method of operation may further comprise receiving, at the UE, an allocated UL-SCH resource for transmission of the message to the base station; and sending, by the UE, the message regarding the status report for the first model to the base station via the allocated UL-SCH resource.

According to some aspects, the message sent to the base station regarding the status report for the first model comprises a Medium Access Control (MAC) Control Element (CE) message or a Radio Resource Control (RRC) message.

According to some aspects, the first SR configuration comprises one of: a particular SR configuration; a predetermined subset of SR configurations; or any type of SR configuration.

According to some aspects, the message sent to the base station regarding the status report for the first model comprises one of: a MAC CE message; or an RRC message, and a size of the allocated UL-SCH resource for transmission of the message to the base station is determined based, at least in part, on whether the message being sent to the base station regarding the status report for the first model is a MAC CE message or an RRC message.

According to some aspects, the method further comprises receiving, at the UE, an indication from the base station of a first subset of models, wherein the act of detecting, at the UE, a need to send a message to the base station regarding a status report for the first model further comprises determining, at the UE, that the first model is in the first subset of models.

According to some aspects, the method further comprises cancelling the triggered first SR before or when sending the message to the base station regarding the status report for the first model. According to some such aspects, the act of cancelling the triggered first SR is performed in response to one or more of the following conditions being met: the message is already sent or multiplexed to the base station in a MAC protocol data unit (PDU); the UE already received an updated version of the first model before the message is sent or multiplexed to the base station in a MAC PDU; the base station has disabled AI-based or ML-based model operations before the message is sent or multiplexed to the base station in a MAC PDU; the UE determines not to continue with AI-based or ML-based model operations before the message is sent or multiplexed to the base station in a MAC PDU; a threshold number of SR transmission attempts has been exceeded by the UE; or the UE initiates a Random Access Channel (RACH) procedure. According to some such aspects, in response to determining that the threshold number of SR transmission attempts have been exceeded, the method further comprises: determining, by the UE, to discontinue use of the first model; or determining, by the UE, to initiate a RACH procedure; and then sending the message to the base station as part of the initiated RACH procedure.

According to some aspects, the method further comprises receiving, at the UE, a second configuration from a base station that associates a second SR configuration with a status report for a second model, wherein the second model relates to at least one task or function based on AI or ML. According to some such aspects, the first SR configuration and the second SR configuration have at least one of: different periodicities; different associated PUCCH configurations; or different SR prohibit timer values.

According to some aspects, the first model is related to one or more tasks of: beam management, channel estimation, channel state information (CSI) compression, UE positioning, determination or setting of at least one parameter for an air interface, or UE mobility management.

According to some aspects, the detecting, at the UE, of a need to send a message to the base station regarding a status report for the first model further comprises at least one of the following: detecting that an accuracy level of the first model has degraded beyond a threshold amount; detecting that the first model has become out of date; or detecting that the first model has failed.

In accordance with one or more additional aspects, another method of operating a UE is disclosed herein, the method comprising: obtaining, at the UE, at least a first model, wherein the first model relates to at least one task or function that is based on AI or ML; detecting, at the UE, a need to send a message to the base station regarding a status report for at least the first model; determining, at the UE, that a UL-SCH resource is not available for transmission of the message to the base station; and triggering, by the UE, a transmission of a first SR to the base station on the PUCCH. According to some aspects, the method may further comprise receiving, at the UE, an allocated UL-SCH resource for transmission of the message to the base station; and sending, by the UE, the message regarding the status report for the first model to the base station via the allocated UL-SCH resource.

The various methods and techniques summarized in this section may likewise be performed by a UE device comprising: a receiver; a transmitter; and a processor configured to perform any of the various methods and techniques summarized herein. The various methods and techniques summarized in this section may likewise be stored as instructions in a non-volatile computer-readable medium, wherein the instructions, when executed, cause the performance of the various methods and techniques summarized herein.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates another example of a wireless communication system, according to some aspects.

FIG. 3 illustrates an example block diagram of a UE, according to some aspects.

FIG. 4 illustrates an example block diagram of a Base Station (BS), according to some aspects.

FIG. 5 illustrates a diagram detailing a method of a UE sending AI/ML model status reports to a base station, according to some aspects.

FIG. 6 illustrates a diagram detailing a method of conditional Scheduling Request (SR) triggering by AI/ML model status reports, according to some aspects.

FIG. 7 illustrates a diagram detailing a method of associating SR configurations per AI/ML model IDs, according to some aspects.

FIG. 8 is a flowchart detailing a method of triggering SRs related to AI/ML model status reports, according to some aspects.

FIG. 9 is a flowchart detailing another method of triggering SRs related to AI/ML model status reports, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

The present application relates to improved user equipment (UE) behaviors in instances of the degradation (or failure) of stored models related to Artificial Intelligence (AI) and/or Machine Learning (ML)-based tasks or functions (i.e., “AI/ML models”). For AI/ML models employed by UEs that are intended to be used for air-interface functionalities, such as: beamforming, channel estimation, demodulation, or low-latency positioning, the AI/ML models should be updated as soon as possible when they have degraded or failed and/or are no longer valid. However, the UE may not have immediate uplink-shared channel (UL-SCH) resources available for the transmission of AI/ML model status reports to a cellular network gNodeB (gNB), e.g., via a Medium Access Control (MAC) Control Element (CE), so there may be an undesirable amount of delay before the UE is able to inform the gNB that some or all of the AI/ML models are either suffering from degraded performance or are no longer valid for performance of their respective tasks or functions. Described herein are techniques to allow UEs to obtain UL-SCH resources for transmission of MAC CEs relating to AI/ML model status reports more rapidly.

The following is a glossary of additional terms that may be used in this disclosure:

Memory Medium—Any of various types of non-transitory memory devices or storage devices. The term “memory medium” is intended to include an installation medium, (e.g., a CD-ROM, floppy disks, or tape device; a computer system memory or random-access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”User Equipment (UE) (also “User Device,” “UE Device,” or “Terminal”)—any of various types of computer systems or devices that are mobile or portable and that perform wireless communications. Examples of UE devices include mobile telephones or smart phones (e.g., iPhone™, Android™-based phones), portable gaming devices (e.g., Nintendo Switch™, Nintendo DS™, PlayStation Vita™, PlayStation Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, and the like. In general, the terms “UE” or “UE device” or “terminal” or “user device” may be broadly defined to encompass any electronic, computing, and/or telecommunications device (or combination of devices) that is easily transported by a user (or vehicle) and capable of wireless communication.

Wireless Device—any of various types of computer systems or devices that perform wireless communications. A wireless device may be portable (or mobile) or may be stationary or fixed at a certain location. A UE is an example of a wireless device.

Communication Device—any of various types of computer systems or devices that perform communications, where the communications may be wired or wireless. A communication device may be portable (or mobile) or may be stationary or fixed at a certain location. A wireless device is an example of a communication device. A UE is another example of a communication device.

Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.

Node—The term “node,” or “wireless node” as used herein, may refer to one more apparatus associated with a cell that provide a wireless connection between user devices and a wired network generally.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).

Band—The term “band” has the full breadth of its ordinary meaning, and at least includes a section of spectrum (e.g., radio frequency spectrum) in which channels are used or set aside for the same purpose.

Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Example Wireless Communication System

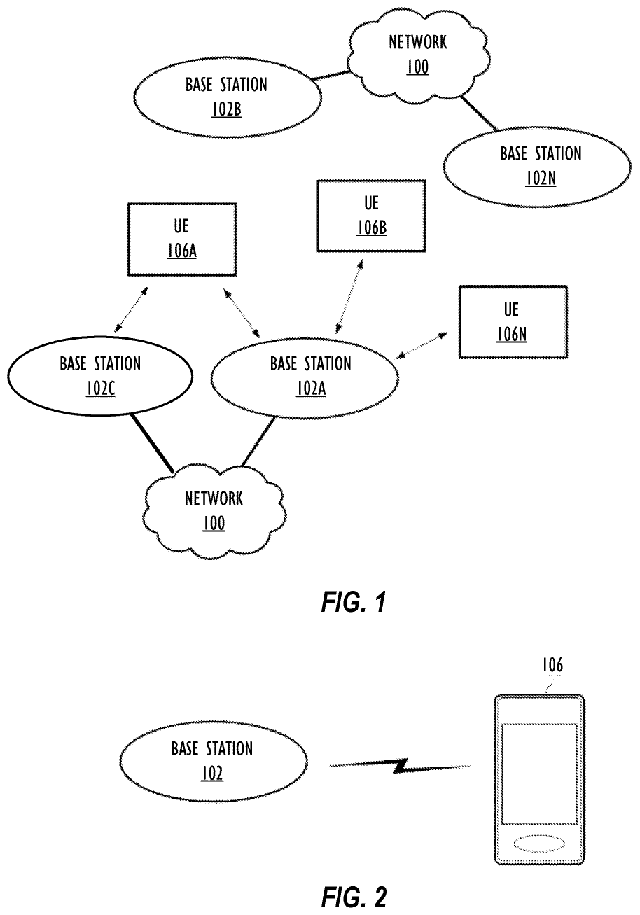

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106N. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2 CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using an SL interface for direct communications between devices. The IoT UEs may also execute background applications (e.g., keep-alive messages, status updates, and the like) to facilitate the connections of the IoT network.

As shown, the UEs 106, such as UE 106A and UE 106B, may directly exchange communication data via an SL interface 108. The SL interface 108 may be a PC5 interface comprising one or more physical channels, including but not limited to a Physical Sidelink Shared Channel (PSSCH), a Physical Sidelink Control Channel (PSCCH), a Physical Sidelink Broadcast Channel (PSBCH), and a Physical Sidelink Feedback Channel (PSFCH).

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (VUEs). The RSU may also include internal data storage circuitry to store intersection map geometry, traffic statistics, media, as well as applications/software to sense and control ongoing vehicular and pedestrian traffic. The RSU may operate on the 5.9 GHz Intelligent Transport Systems (ITS) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weather enclosure suitable for outdoor installation, and it may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106N and similar devices over a geographic area via one or more cellular communication standards.

Thus, while base station 102A may act as a “serving cell” for UEs 106A-106N as illustrated in FIG. 1, each UE 106 may also be capable of receiving signals from (and possibly within communication range of) one or more other cells (which may be provided by base stations 102B-102N and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102N may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to at least one of the cellular communication protocol discussed in the definitions above. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

As illustrated in FIG. 2, in one or more embodiments, the UE 106 may be a device with cellular communication capability such as a mobile phone, a hand-held device, a computer, a laptop, a tablet, a smart watch, or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a baseband processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1×RTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource selection. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2 ,4, or 8).

### Example Communication Device

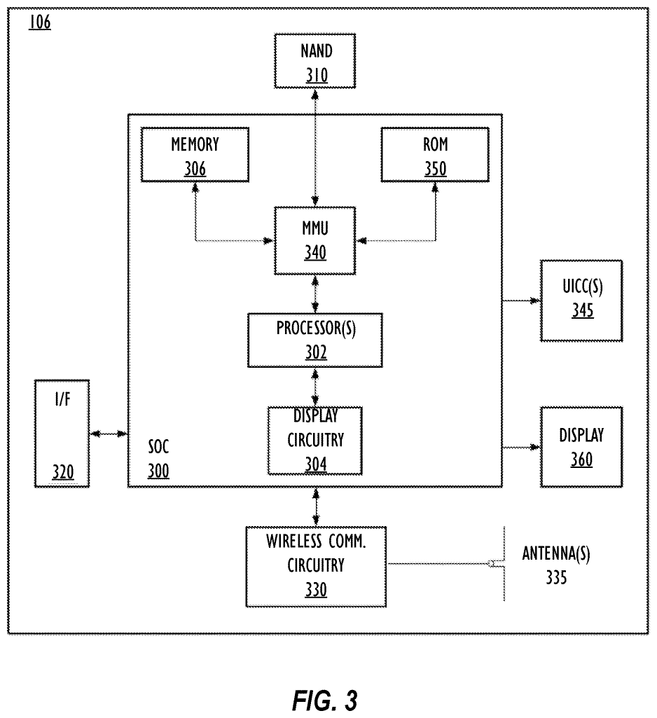

FIG. 3 illustrates an example simplified block diagram of a communication device 106, according to some aspects. It is noted that the block diagram of the communication device of FIG. 3 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components configured to perform core functions. For example, this set of components may be implemented as a system on chip (SOC), which may include portions for various purposes. Alternatively, this set of components may be implemented as separate components or groups of components for the various purposes. The set of components may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; and the like), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 330 may couple (e.g., communicatively; directly or indirectly) to one or more antennas, such as antenna(s) 335 as shown. The wireless communication circuitry 330 may include cellular communication circuitry and/or short to medium range wireless communication circuitry, and may include multiple receive chains and/or multiple transmit chains for receiving and/or transmitting multiple spatial streams, such as in a MIMO configuration.

In some aspects, as further described below, cellular communication circuitry 330 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 330 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mmWave frequencies. As mmWave systems operate in higher frequencies than typically found in LTE systems, signals in the mmWave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements.

The communication device 106 may further include one or more smart cards 345 that include Subscriber Identity Module (SIM) functionality, such as one or more Universal Integrated Circuit Card(s) (UICC(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some aspects, the MMU 340 may be included as a portion of the processor(s) 302.

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein (e.g., by executing program instructions stored on a memory medium). Alternatively (or in addition), processor 302 may be configured as a programmable hardware element, such as a Field Programmable Gate Array (FPGA), or as an Application Specific Integrated Circuit (ASIC). Alternatively (or in addition) the processor 302 of the communication device 106, in conjunction with one or more of the other components 300, 304, 306, 310, 320, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, and the like) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, and the like) configured to perform the functions of wireless communication circuitry 330.

### Example Base Station

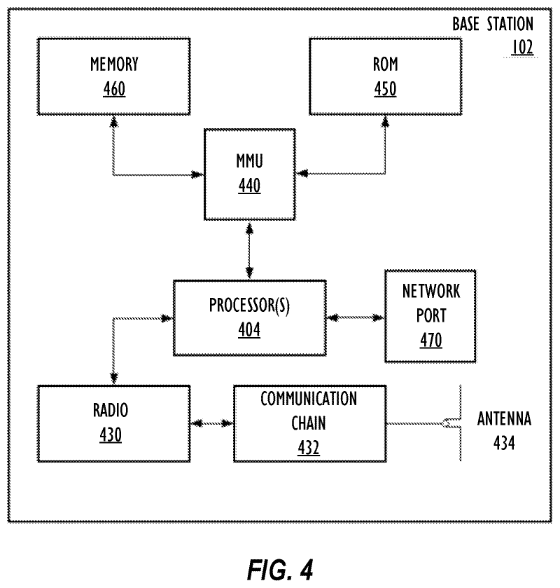

FIG. 4 illustrates an example block diagram of a base station 102, according to some aspects. It is noted that the base station of FIG. 4 is a non-limiting example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIG. 1.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some aspects, base station 102 may be a next generation base station, (e.g., a 5G New Radio (5G NR) base station, or “gNB”). In such aspects, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including 5G NR, LTE, LTE-A, GSM, UMTS, CDMA2000, Wi-Fi, and the like.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mmWave, the 5G NR radio may be coupled to one or more mmWave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, and the like).

Further, the BS 102 may include hardware and software components for implementing or supporting implementation of features described herein. The processor 404 of the base station 102 may be configured to implement or support implementation of part or all of the methods described herein (e.g., by executing program instructions stored on a memory medium). Alternatively, the processor 404 may be configured as a programmable hardware element, such as a Field Programmable Gate Array (FPGA), or as an Application Specific Integrated Circuit (ASIC), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, and the like) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, and the like) configured to perform the functions of radio 430.

### AI/ML Model Status Reporting and Failure Recovery

Based on the envisioned AI/ML framework to be defined for Release-18 and beyond, a network may provide a number of different AI/ML-based models to a UE for different purposes or tasks or functions, for example: an AI/ML Model #1 for beam management; an AI/ML Model #2 for channel estimation; an AI/ML Model #3 for CSI compression; an AI/ML Model #4 for mobility management, and so forth.

However, these AI/ML-based models may fail, degrade, or gradually become invalid or outdated due to UE status variation, such as: a change in UE mobility level; a change in the UE's location; a change in the UE's application activities, and so forth. Alternatively, a UE may trigger an SR related to an AI/ML-based model for model conditions other than failure or degradation (e.g., the success of a model, or simply the fact that the parameters of a model have been updated by a UE, etc.). A network may not be aware of any AI/ML model degradation occurring at the UE side, so it may not be able to update the AI/ML model in time. Alternatively, a network could continuously update AI/ML models periodically, but it may be quite resource consuming to do so.

One potential solution to this issue would be for the UE to send a model failure recovery message to the network (e.g., via a MAC CE), wherein the message could indicate which AI/ML model(s) need updating or replacement. For example, a MAC CE-based AI/ML model status report message may be used for AI/ML-based tasks or functions related to air interface optimization (e.g., beam management). By contrast, if the AI/ML models are intended to be used for other air interface functionalities, such as: beamforming, channel estimation, demodulation, or low-latency positioning, the AI/ML models should be updated more immediately when they are no longer valid. However, a UE may not have immediate access to UL-SCH resources for the transmission of such an AI/ML model status report via MAC CE, so there could be an undesirable amount of delay before the UE is able to inform the gNB that some (or all) AI/ML models have degraded in performance or are no longer valid for use. Thus, it would be desirable for UEs to be able to obtain more immediate access to the UL-SCH resource needed for transmission of MAC CE messages (or other formats of messages) relating to AI/ML model status.

### SR Triggering for AI/ML Model Status MAC CE

Based on the current 3GPP framework, a UE may get an uplink resource allocation by triggering a scheduling request (SR). An SR is a Layer 1 (Physical Layer) signal or message sent by a UE to a gNB to ask for an Uplink (UL) grant to send the Uplink data over the Physical Uplink Shared Channel (PUSCH). The UL grant may be sent to the UE by the gNB over a Physical Downlink Control Channel (PDCCH) transmission, e.g., in DCI Format 0_0 or Format 0_1.

However, according to Technical Specification (TS) 38.321, an SR can currently only be triggered by a few conditions, including: UL data availability in one or more logical channels (LCHs) (e.g., triggered by buffer status report (BSR) operations); Secondary Cell (SCell) beam failure recovery; consistent Listen Before Talk (LBT) failure recovery (e.g., for NR-U unlicensed band operation); or beam failure recovery of Beam Failure Detection Reference Signal (BFD-RS) set(s). Each logical channel, SCell beam failure recovery, beam failure recovery of BFD-RS set and consistent LBT failure recovery, may be mapped to zero or one SR configurations, which may be configured by RRC. The SR configuration of the logical channel that triggered a BSR or the SCell beam failure recovery or the beam failure recovery of BFD-RS set or the consistent LBT failure recovery (if such a configuration exists) is considered to be a corresponding SR configuration for the triggered SR. Any SR configuration may be used for an SR triggered by pre-emptive BSR. Thus, it would be beneficial to further include an SR configuration type specifically for AI/ML model status reporting, so that a UE can rapidly request UL-SCH resource for the transmission of MAC CE messages relating to AI/ML model status reporting.

From a gNB perspective, if the gNB then detects a SR on the PUCCH mapping to the SR configuration corresponding to the new AI/ML model failure condition, the gNB may allocate a UL-SCH resource for the UE to transmit the AI/ML model status report MAC CE. When the gNB receives such a MAC CE, the gNB can further determine if and/or how the AI/ML models should be updated at the UE side. In another embodiment, the AI/ML model status report MAC CE may not be configured to be associated with any particular SR configuration, but the UE can trigger any SR when it intends to transmit an AI/ML model status report MAC CE.

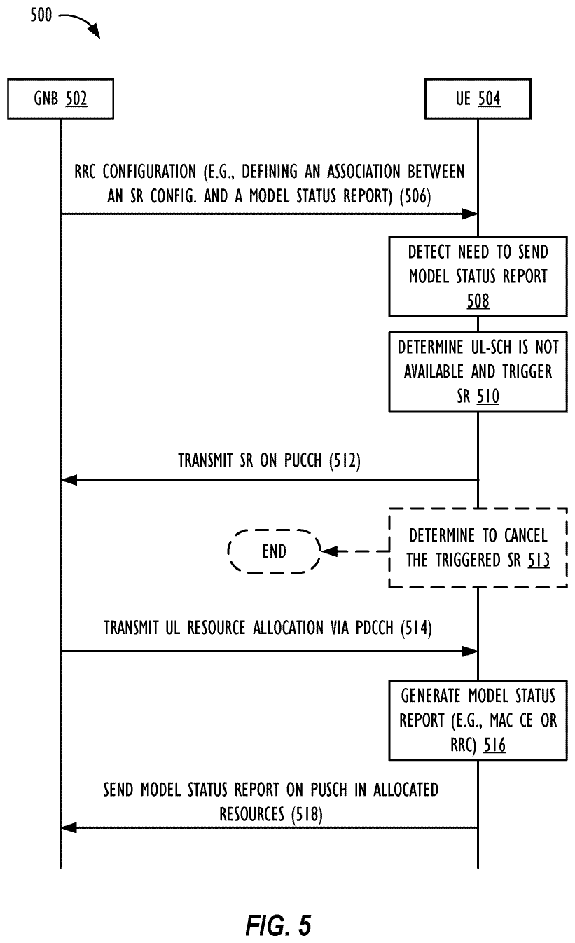

Turning now to FIG. 5, a diagram 500 detailing a method of a UE 504 sending AI/ML model status reports to a base station (e.g., gNB 502) is illustrated, according to some aspects. Diagram 500 may begin at step 506, wherein gNB 502 may use RRC configuration to establish one or more associations between an SR configuration and an AI/ML model status report. Later, e.g., during operation by an end-user, at block 508, the UE 504 may detect a need to send a model status report to the gNB 502 (e.g., if a particular model has degraded, failed, become obsolete based on the UE's current conditions, etc.). In some embodiments, it may also be possible that the network can request the UE to transmit a MAC CE related to AI/ML model status, i.e., rather than only transmitting when the UE has determined a need to send the model status report.

At block 510, UE 504 may determine that sufficient UL-SCH resources are not available and thus trigger an SR to the gNB 502 (e.g., based on the aforementioned SR configuration that is associated with the particular model that the UE needs to send a status report regarding). At step 512, the SR may be transmitted to the gNB 502 via the PUCCH.

According to some aspects, as shown a block 513, a UE may also determine it is appropriate to cancel the triggered SR, at which point diagram 500 may terminate. Some scenarios when a UE may decide to cancel an already-triggered SR are described in further detail below.

Returning to diagram 500, at step 514, the gNB 502 may transmit an UL resource allocation (e.g., a PUSCH allocation for the UE 504 to use for its AI/ML model status report) via the PDCCH. At block 516, UE 504 may generate the model status report (e.g., in the form of a MAC CE or even an RRC message). Finally, at step 518, the UE 504 may send the model status report to the gNB 502 (e.g., in the form of a MAC CE message on the PUSCH).

As mentioned above, it is also possible that the AI/ML model status reporting may be conveyed by an RRC message, rather than a MAC CE, for example, if the UE intends to include additional details about AI/ML model status. For example, if a particular model is used for DL reception, the UE may wish to report additional details regarding the resultant error rate caused due to use of the model. In another example, the additional details may be related to the degree by which the model has degraded and/or the duration of time for which the model has already been in a degraded state, and so forth. In such cases, the UE may trigger an SR based on: a specific SR configuration; any SR configuration in a specific subset of SR configurations; or any SR configuration.

In some embodiments, the UE may use MAC CE messages and RRC message in a complimentary fashion. For example, if the UE triggers a SR corresponding to AI/ML model status reporting MAC CE, the gNB may assign a UL-SCH resource with limited size (but enough for the intended MAC CE). If, instead, the UE triggers a SR corresponding to AI/ML model status reporting RRC message, the gNB may assign a UL-SCH resource with larger size (i.e., large enough for the RRC message report).

### Conditional SR Triggering by AI/ML Model Status Reporting

When a UE detects a need to send an AI/ML model status report, it can further determine if a SR should be triggered, e.g., based on which AI/ML model it is that requires the update. For example, if the update is needed for an AI/ML model dedicated to beam management, the UE may trigger the SR immediately, in order to send the MAC CE to the gNB more quickly. On the other hand, if the update is needed for an AI/ML model dedicated to other, e.g., less urgent purposes, the UE may refrain from triggering the SR at the present time and only send the MAC CE when the UL-SCH resources becomes available.

According to some aspects, a gNB may first indicate a subset of AI/ML models to a UE via their model IDs, and the UE will be configured to only trigger a new SR if the AI/ML model status report is regarding an AI/ML model within the indicated AI/ML model ID subset indicated by the gNB.

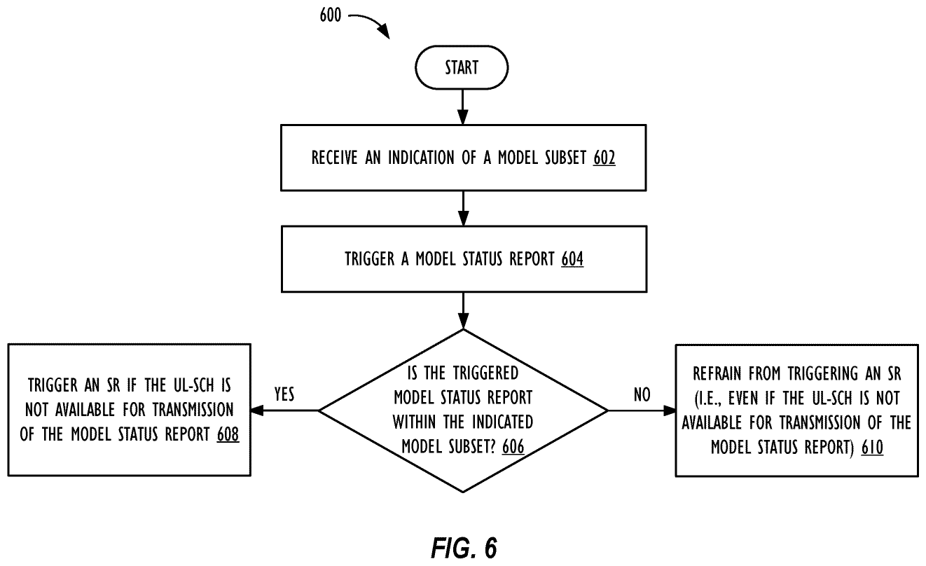

Turning now to FIG. 6, a diagram 600 detailing such a method of conditional Scheduling Request (SR) triggering by AI/ML model status reports is illustrated, according to some aspects. First, at block 602, a UE may receive an indication of a subset of AI/ML model IDs (e.g., two or more IDs relating to AI/ML models). Next, at block 604, the UE may determine a need to trigger a model status report, e.g., related to some AI/ML model that it is using.

Next, at decision block 606, the UE may evaluate whether the triggered model status report's ID is within the indicated subset of model IDs. If so (i.e., “YES” at block 606), then the UE may proceed to block 608 and trigger an SR if the UL-SCH is not available for transmission of the model status report. If, instead, the triggered model status report ID is not within the subset (i.e., “NO” at block 606), then the UE may proceed to block 610 and refrain from triggering an SR (i.e., even if the UL-SCH is not available for transmission of the model status report), on the grounds that this model is not currently of interest since it is not listed in the current model subset. In some embodiments, particular model IDs may be included (or not included) in a conditional model subset based on the perceived priority levels of such models for a given scenario. In still other embodiments, a ModelGroupID may also be used to identify a group of two or more models having a shared priority level or other characteristic.

### Cancellation of Pending SRs Triggered by AI/ML Model Status Reports

According to some aspects, once an SR is triggered for AI/ML model status reporting by a UE and has become pending, it may be cancelled when at least one of the following conditions occurs: (a) the AI/ML model status report message is already sent or multiplexed to the base station in a MAC protocol data unit (PDU); (b) the UE already received an updated version of the AI/ML model before the status report message was sent or multiplexed to the base station in a MAC PDU; (c) the base station has disabled AI-based or ML-based model operations before the status report message is sent or multiplexed to the base station in a MAC PDU; (d) the UE determines not to continue with AI-based or ML-based model operations before the status report message is sent or multiplexed to the base station in a MAC PDU; (e) a threshold number of SR transmission attempts has been exceeded by the UE; or (f) the UE initiates a Random Access Channel (RACH) procedure.

According to other aspects, if the number of SR transmission (i.e., an SR_COUNTER value) reaches the value of sr-TransMax, the UE may take one or more of the following behaviors: (a) releasing the one or more AI/ML models that have triggered the AI/ML model status reporting (e.g., the UE may release the failed AI/ML model and fall back to classical (i.e., non AI/ML-based) operation for the functionality that the failed AI/ML model was used for) and/or (b) initiating a RACH procedure and canceling the SR. The UE may further transmit the intended AI/ML model

### Status Report Mac Ce in the Rach Signaling.

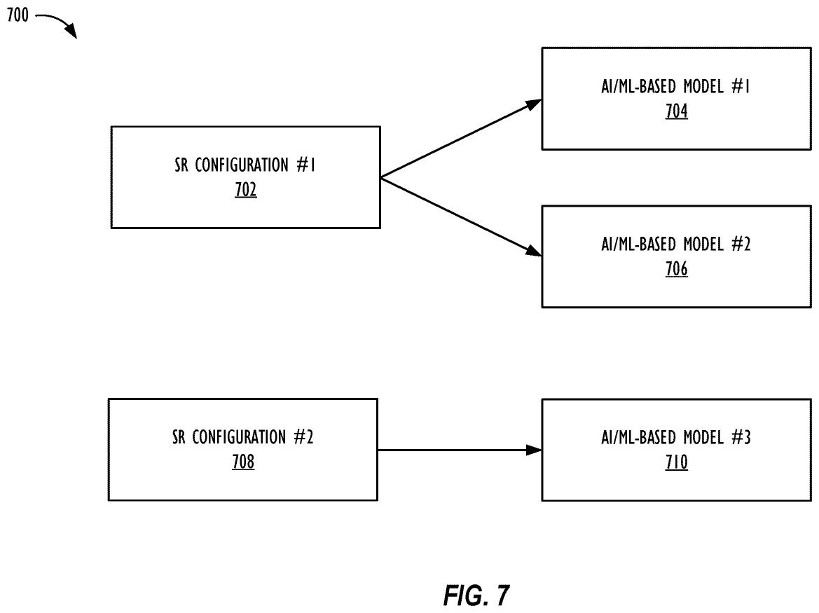

Turning now to FIG. 7, a diagram 700 detailing a method of associating SR configurations per AI/ML model IDs is illustrated, according to some aspects. According to diagram 700, SR configuration #1 (702) is mapped to AI/ML models #1 (704) and #2 (706), and SR configuration #2 (708) is mapped to AI/ML model #3 (710). Each SR configuration may have a different periodicity, SR prohibit timer value, and/or associated PUCCH resources, so the mapping could be configured based on delay sensitivity and/or priority level of each AI/ML model.

As mentioned above, the SR can triggered by AI/ML model failure. Based on the mapping between SR configurations and AI/ML models (e.g., via their model IDs), the base station may directly interpret which AI/ML model has failed (or requires update) based on the received SR transmission. In such cases, the UE does not even have to send the AI/ML model status report (e.g., in a MAC CE message).

In some embodiments, an AI/ML model may not be associated to any SR configuration, and the UE may thus: (a) refrain from triggering any SR when this AI/ML model has failed or requires an update, or (b) trigger any SR when such an unassociated AI/ML model has failed or require update.

### Exemplary Methods

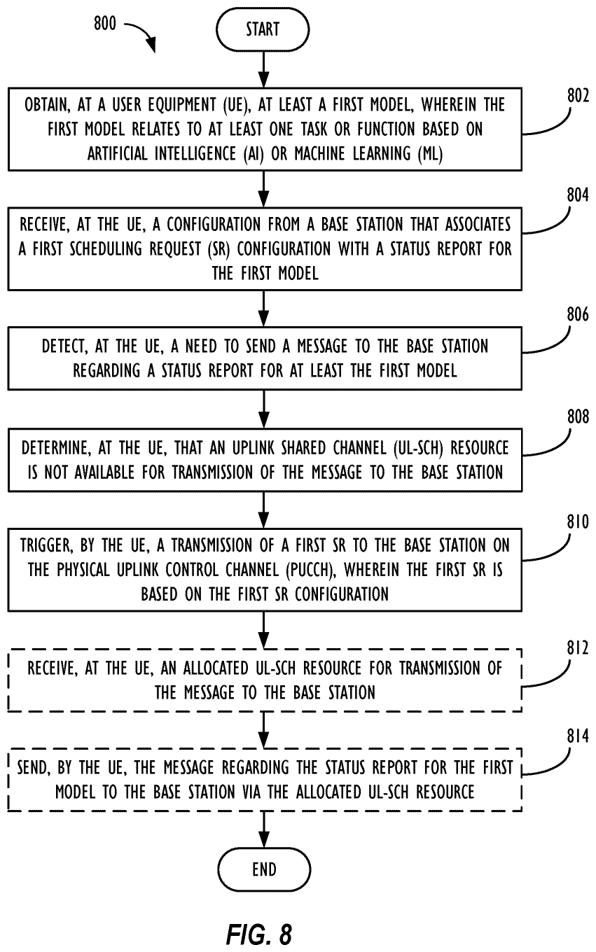

Turning now to FIG. 8, a flowchart detailing a method 800 of triggering SRs related to AI/ML model status reports is illustrated, according to some aspects. First, at block 802, a UE practicing the method 800 may obtain at least a first model, wherein the first model relates to at least one task or function based on AI or ML (e.g., the first model may be obtained from a network, or it may be obtained from elsewhere, such as its own memory, another UE, a third party server, etc.). Next, at block 804, the UE may receive a configuration from a base station that associates a first scheduling request (SR) configuration with a status report for the first model. Next, at block 806, the UE may detect a need to send a message to the base station regarding a status report for at least the first model (e.g., if the first model has become invalid, outdated due to changing UE status, etc.).

Next, at block 808, the UE may determine that an uplink shared channel (UL-SCH) resource is not available for transmission of the message to the base station. In response, at block 810, the UE may trigger a transmission of a first SR to the base station on the Physical Uplink Control Channel (PUCCH), wherein the first SR is based on the first SR configuration.

At block 812, the method 800 may optionally proceed with the UE receiving an allocated UL-SCH resource for transmission of the message to the base station and then (at block 814) actually sending the message regarding the status report for the first model to the base station, i.e., via the allocated UL-SCH resource.

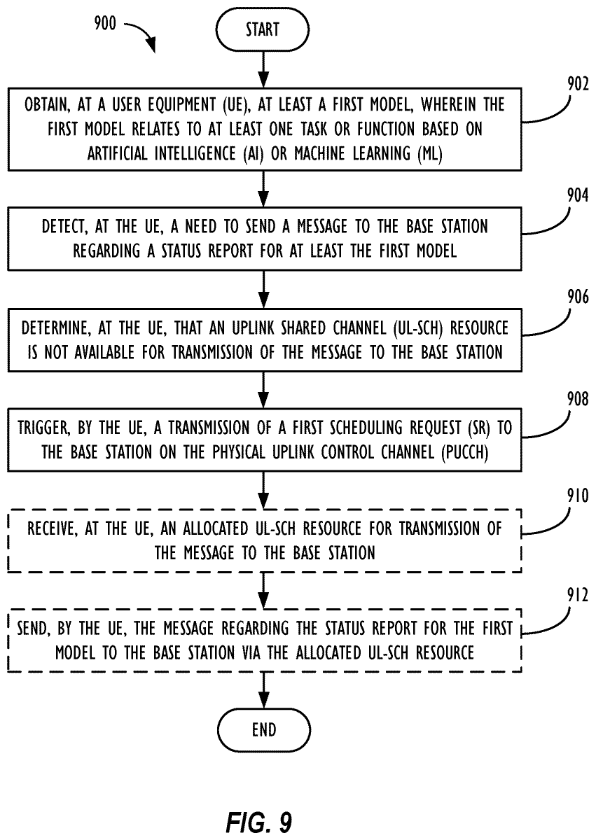

Turning now to FIG. 9, a flowchart detailing another method 900 of triggering SRs related to AI/ML model status reports is illustrated, according to some aspects. First, at block 902, a UE practicing the method of 900 may obtain at least a first model, wherein the first model relates to at least one task or function based on AI or ML (e.g., the first model may be obtained from a network, or it may be obtained from elsewhere, such as its own memory, another UE, a third party server, etc.).

Next, at block 904, the UE may detect a need to send a message to the base station regarding a status report for at least the first model. At block 906, the UE may determine that a UL-SCH resource is not available for transmission of the message to the base station. In response, at block 908, the UE may trigger a transmission of a first SR to the base station on the PUCCH.

At block 910, the method 900 may optionally proceed with the UE receiving an allocated UL-SCH resource for transmission of the message to the base station and then (at block 912) actually sending the message regarding the status report for the first model to the base station, i.e., via the allocated UL-SCH resource.

### Additional Comments

The use of the connective term “and/or” is meant to represent all possible alternatives of the conjunction “and” and the conjunction “or.” For example, the sentence “configuration of A and/or B” includes the meaning and of sentences “configuration of A and B” and “configuration of A or B.”

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or any subset of any of the method aspects described herein, or any combination of such subsets).

In some aspects, a device (e.g., a UE 106, a BS 102) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method of operating a user equipment (UE), the method comprising:
obtaining, at the UE, at least a first model, wherein the first model relates to at least one task or function based on artificial intelligence (AI) or machine learning (ML);
receiving, at the UE, a configuration from a base station that associates a first scheduling request (SR) configuration with a status report for the first model;
detecting, at the UE, a need to send a message to the base station regarding a status report for the first model;
determining, at the UE, that an uplink shared channel (UL-SCH) resource is not available for transmission of the message to the base station; and
triggering, by the UE, a transmission of a first SR to the base station on the Physical Uplink Control Channel (PUCCH), wherein the first SR is based on the first SR configuration.

2. The method of claim 1, further comprising:
receiving, at the UE, an allocated UL-SCH resource for transmission of the message to the base station; and
sending, by the UE, the message regarding the status report for the first model to the base station via the allocated UL-SCH resource.

3. The method of claim 2, wherein the message sent to the base station regarding the status report for the first model comprises a Medium Access Control (MAC) Control Element (CE) message.

4. The method of claim 2, wherein the message sent to the base station regarding the status report for the first model comprises a Radio Resource Control (RRC) message.

5. The method of claim 2, wherein the first SR configuration comprises one of: a particular SR configuration; a predetermined subset of SR configurations; or any type of SR configuration.

6. The method of claim 2, wherein:
the message sent to the base station regarding the status report for the first model comprises one of: a MAC CE message; or an RRC message, and
a size of the allocated UL-SCH resource for transmission of the message to the base station is determined based, at least in part, on whether the message being sent to the base station regarding the status report for the first model is a MAC CE message or an RRC message.

7. The method of claim 1, further comprising:
receiving, at the UE, an indication from the base station of a first subset of models,
wherein the act of detecting, at the UE, a need to send a message to the base station regarding a status report for the first model further comprises:
determining, at the UE, that the first model is in the first subset of models.

8. The method of claim 1, further comprising:
cancelling the triggered first SR before or when sending the message to the base station regarding the status report for the first model.

9. The method of claim 8, wherein the act of cancelling the triggered first SR is performed in response to one or more of the following conditions being met:
the message is already sent or multiplexed to the base station in a MAC protocol data unit (PDU);
the UE already received an updated version of the first model before the message is sent or multiplexed to the base station in a MAC PDU;
the base station has disabled AI-based or ML-based model operations before the message is sent or multiplexed to the base station in a MAC PDU;
the UE determines not to continue with AI-based or ML-based model operations before the message is sent or multiplexed to the base station in a MAC PDU;
a threshold number of SR transmission attempts has been exceeded by the UE; or the UE initiates a Random Access Channel (RACH) procedure.

10. The method of claim 9, wherein, in response to determining that the threshold number of SR transmission attempts have been exceeded, the method further comprises:
determining, by the UE, to discontinue use of the first model.

11. The method of claim 9, wherein, in response to determining that the threshold number of SR transmission attempts have been exceeded, the method further comprises:
determining, by the UE, to initiate a RACH procedure; and
sending the message to the base station as part of the initiated RACH procedure.

12. The method of claim 1, further comprising:
receiving, at the UE, a second configuration from a base station that associates a second SR configuration with a status report for a second model,
wherein the second model relates to at least one task or function based on AI or ML.

13. The method of claim 12, wherein the first SR configuration and the second SR configuration have at least one of: different periodicities; different associated PUCCH configurations; or different SR prohibit timer values.

14. The method of claim 1, wherein the first model is related to one or more tasks of: beam management, channel estimation, channel state information (CSI) compression, UE positioning, determination or setting of at least one parameter for an air interface, or UE mobility management.

15. The method of claim 1, wherein the configuration from the base station is received via an RRC message.

16. The method of claim 1, wherein detecting, at the UE, a need to send a message to the base station regarding a status report for the first model further comprises at least one of the following:
detecting that an accuracy level of the first model has degraded beyond a threshold amount;
detecting that the first model has become out of date; or
detecting that the first model has failed.

17. (canceled)

18. (canceled)

19. A user equipment (UE) device comprising: a receiver; a transmitter; and a processor configured to perform operations comprising:
obtaining, at the UE, at least a first model, wherein the first model relates to at least one task or function based on artificial intelligence (AI) or machine learning (ML);
receiving, at the UE, a configuration from a base station that associates a first scheduling request (SR) configuration with a status report for the first model;
detecting, at the UE, a need to send a message to the base station regarding a status report for the first model;
determining, at the UE, that an uplink shared channel (UL-SCH) resource is not available for transmission of the message to the base station; and
triggering, by the UE, a transmission of a first SR to the base station on the Physical Uplink Control Channel (PUCCH), wherein the first SR is based on the first SR configuration.

20. (canceled)

21. A baseband processor configured to cause a user equipment (UE) to perform operations comprising:
obtaining, at the UE, at least a first model, wherein the first model relates to at least one task or function based on artificial intelligence (AI) or machine learning (ML);
receiving, at the UE, a configuration from a base station that associates a first scheduling request (SR) configuration with a status report for the first model;
detecting, at the UE, a need to send a message to the base station regarding a status report for the first model;
determining, at the UE, that an uplink shared channel (UL-SCH) resource is not available for transmission of the message to the base station; and
triggering, by the UE, a transmission of a first SR to the base station on the Physical Uplink Control Channel (PUCCH), wherein the first SR is based on the first SR configuration.

22. The UE device of claim 19, wherein the processor is further configured to perform operations comprising:
receiving, at the UE, an allocated UL-SCH resource for transmission of the message to the base station; and
sending, by the UE, the message regarding the status report for the first model to the base station via the allocated UL-SCH resource.

23. The baseband processor of claim 21, wherein the baseband processor is further configured to cause a user equipment (UE) to perform operations comprising:
receiving, at the UE, an allocated UL-SCH resource for transmission of the message to the base station; and
sending, by the UE, the message regarding the status report for the first model to the base station via the allocated UL-SCH resource.
